(19) United States
(12) Patent Application Publication
(10) Pub. No.: US 2009/0208166 A1
(43) Pub. Date: Aug. 20, 2009

(54) THREE-DIMENSIONAL PERIODIC STRUCTURE INCLUDING ANTI-REFLECTION STRUCTURE AND LIGHT-EMITTING DEVICE

(75) Inventors: Kiyokatsu Ikemoto, Yokohama-shi (JP); Akinari Takagi, Yokosuka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/368,728

(22) Filed: Feb. 10, 2009

(30) Foreign Application Priority Data
Feb. 14, 2008 (JP) 2008-032734
Feb. 6, 2009 (JP) 2009-026619

(51) Int. Cl. G02B 6/12; G02B 6/26

(52) U.S. Cl. 385/14; 385/28

(57) ABSTRACT

The three-dimensional structure includes a first waveguide (line defect) in a three-dimensional photonic crystal formed by periodically arranging first and second media, which causes light to propagate therein in a first guide mode, a second waveguide (line defect) in the three-dimensional photonic crystal, which causes light to propagate therein in a second guide mode, reflective portions provided in the first and second waveguides to reflect parts of the lights propagating in the first and second waveguides, and
a first region connected to the second waveguide so as to cause at least part of the light that has propagated in the second waveguide via the reflective portion to propagate therein in a third guide mode. The reflective portions are formed of media having refractive indexes different from those the first and second waveguides. Each reflective portion has a homogeneous refractive index distribution in an entire section orthogonal to a waveguide-extending direction.

### BACKGROUND OF THE INVENTION

The present invention relates to a three-dimensional structure which includes an anti-reflection structure in a three-dimensional photonic crystal having a three-dimensional periodic structure, and a light-emitting device using the same.

Yablonovitch has suggested in “Physical Review Letters, Vol. 58, pp. 2059, 1987” that a periodic structure called a photonic crystal having a period equal to or shorter than an incident wavelength enables control of transmission and reflection characteristics of light as an electromagnetic wave.

Use of the photonic crystal having a so-called photonic band gap enables realization of an optical element having a new function. For example, a point defect or a line defect provided in the photonic crystal serves as a resonator or a waveguide.

When the line defect serving as the waveguide is provided in the photonic crystal, light propagates therein in a state of having a unique electromagnetic energy distribution according to a structure of the waveguide. Outside the photonic crystal, light propagates in a state of having a unique electromagnetic energy distribution according to a structure of the outside.

Hereinafter, the state of the light propagating with a unique electromagnetic energy distribution is referred to as a guide mode of the light. Further, a unique electromagnetic energy distribution in a certain guide mode is referred to as a guide mode pattern. A waveguide in the photonic crystal is referred to as a waveguide 1, and a guide mode of light propagating in the waveguide 1 is referred to as a guide mode 1.

The light of the guide mode 1 propagating in the waveguide 1 in the photonic crystal is coupled with light propagating in a guide mode (guide mode 2) different from the guide mode 1, in other words, made usable by converting the guide mode. Hereinafter, a ratio at which energy of the light propagating in the guide mode 1 is converted into energy of light propagating in the guide mode 2 when the light propagating in the guide mode 1 is coupled with the light propagating in the guide mode 2 is referred to as coupling efficiency.

When the waveguide 1 in the photonic crystal is connected with a structure in which light propagates in the guide mode 2, part of the light propagating in the waveguide 1 in the guide mode 1 is coupled with the light propagating in the guide mode 2. Further, part of the light propagating in the guide mode 1 becomes a reflected wave to propagate in the waveguide 1.

In order to convert the light propagating in the guide mode 1 into the light propagating in the guide mode 2 and use the converted light efficiently, improvement of the coupling efficiency of the light propagating in the guide mode 1 and the light propagated in the guide mode 2 and reduction of the reflected wave propagating in the waveguide 1 are required.

To meet such requirements, Japanese Patent Laid-Open No. 2003-315572 discloses an example in which a waveguide 2 as a tapered defect is formed between a waveguide 1 and a free space in a photonic crystal by gradually increasing a width of a line defect. A guide mode of light propagating in the free space is referred to as a guide mode 2, while a guide mode of light propagating in the waveguide 2 formed by the tapered defect is referred to as a guide mode 3. In Japanese Patent Laid-Open No. 2003-315572, connecting the waveguide 2 with the waveguide 1 and the free space causes the light of the guide mode 1 propagating in the waveguide 1 to be converted into light of the guide mode 3 having a pattern shape similar to that of the guide mode 2, thereby causing the light of the guide mode 3 to be coupled with the light of the guide mode 2. Thus, the coupling efficiency of the light propagating in the waveguide 1 in the guide mode 1 and the light propagating in the free space in the guide mode 2 can be improved, and a reflected wave propagating in the waveguide 1 can be reduced.

In the structure disclosed in Japanese Patent Laid-Open No. 2003-315572, the guide mode 1 of the light propagating in the waveguide 1 in the photonic crystal and the guide mode 3 of the light propagating in the waveguide 2 formed by the tapered defect are mutually different guide modes. Therefore, connection of the waveguides 1 and 2 causes part of the light propagating in the waveguide 1 in the guide mode 1 to become a reflected wave. This reflected wave is a loss since it is not coupled with the light propagating in the guide mode 3. In other words, in the connection portion of the waveguides 1 and 2, part of the light propagating in the guide mode 1 cannot be suppressed from becoming the reflected wave.

### BRIEF SUMMARY OF THE INVENTION

The present invention provides a three-dimensional structure which suppresses generation of a reflected wave in a connection portion by using an easily produced structure to improve coupling efficiency when a waveguide in a three-dimensional photonic crystal is connected to a region where light propagating in a guide mode different from a guide mode in the waveguide. The present invention provides a light-emitting device which uses the three-dimensional structure.

The present invention provides as one aspect thereof a three-dimensional structure including a first waveguide which is formed as a line defect in a three-dimensional photonic crystal constituted by periodically arranging a first medium and a second medium having a refractive index smaller than that of the first medium, and which causes light to propagate therein in a first guide mode, a second waveguide which is formed as a line defect in the three-dimensional photonic crystal, and which causes light to propagate therein in a second guide mode, reflective portions provided in the first and second waveguides to respectively reflect parts of the lights propagating in the first and second waveguides, and a first region connected to the second waveguide so as to cause at least part of the light that has propagated in the second waveguide via the reflective portion to propagate therein in a third guide mode different from the second guide mode. The reflective portions are formed of media having refractive indexes different from those of media forming the first and second waveguides. Each of the reflective portions has a homogeneous refractive index distribution in an entire section orthogonal to a direction in which each of the first and second waveguides extends.

The present invention provides as another aspect thereof a light-emitting device including the above three-dimensional structure, a resonator formed by providing a point defect in a three-dimensional photonic crystal, and a second region which is disposed outside the three-dimensional photonic crystal and has a homogeneous refractive index distribution. A gain medium is disposed in the resonator. Light generated in the resonator by exciting the gain medium is amplified by the resonator, and the amplified light propagates in the first waveguide and the first region to be output to the second region.

### BRIEF DESCRIPTION OF THE DRAWINGS

FIG. 1 is a schematic view of a three-dimensional structure which is Embodiment 1 of the present invention.

FIG. 2 is a schematic view of a three-dimensional structure which is Embodiment 2 of the present invention.

FIG. 3 is a perspective view of the three-dimensional structure of Embodiment 2.

FIG. 4 is an x-z sectional view showing each layer of the three-dimensional structure of Embodiment 2.

FIG. 5A is an x-y sectional view of a reflective portion in Embodiment 2.

FIG. 5B is an x-z sectional view of the reflective portion in Embodiment 2.

FIG. 6 is a graph showing calculation results of intensity of returning light in Embodiment 2.

FIG. 7 is a graph showing calculation results of a cosine value of a phase amount Φ in Embodiment 2.

FIG. 8 is a graph showing calculation results of intensity of the returning light in Embodiment 2.

FIG. 9 is a graph showing calculation results of a reflectance of the reflective portion in Embodiment 2.

FIG. 10 is a schematic view of a three-dimensional structure which is Embodiment 3 of the present invention.

FIG. 11 is a graph showing calculation results of intensity of returning light in Embodiment 3.

FIG. 12 is a graph showing calculation results of a cosine value of a phase amount Φ in Embodiment 3.

FIG. 13 is a graph showing calculation results of intensity of the returning light in Embodiment 3.

FIG. 14 is a schematic view showing a structure of a light-emitting device which is Embodiment 4 of the present invention.

FIG. 15 is a schematic view of a three-dimensional structure which is Embodiment 5 of the present invention.

### DETAILED DESCRIPTION OF THE EMBODIMENTS

Exemplary embodiments of the present invention will hereinafter be described with reference to the accompanying drawings.

### Embodiment 1

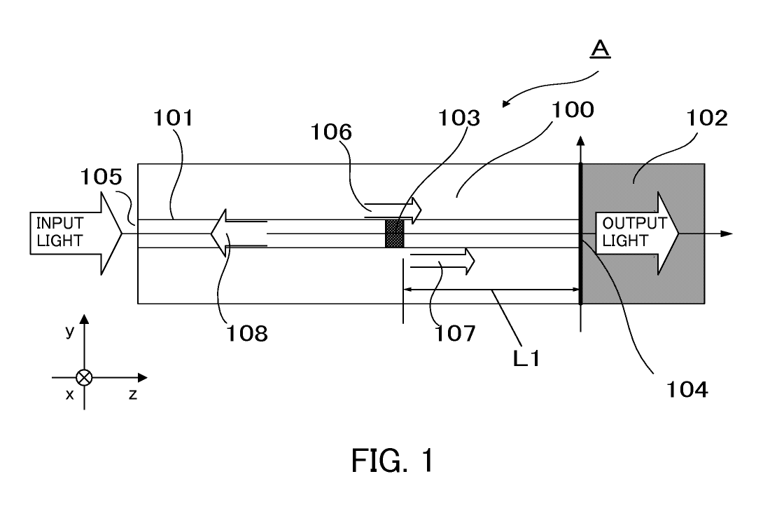

Description will be made of a three-dimensional structure that is Embodiment 1 of the present invention with reference to FIG. 1. Embodiment 1 describes an operation principle of the three-dimensional structure which is common to other embodiments described below. FIG. 1 shows a schematic configuration of a three-dimensional structure A including an anti-reflection structure.

The three-dimensional structure A includes a waveguide (first waveguide) 101 and a reflective portion 103 in a three-dimensional photonic crystal structure (hereinafter simply referred to as a photonic crystal) 100. The three-dimensional structure A further includes an output region (first region) 102.

In this embodiment, a left waveguide with respect to the reflective portion 103 in FIG. 1 is also referred to as a first waveguide, and a right waveguide formed between the reflective portion 103 and the first region 102 is also referred to as a second waveguide. However, in Embodiment 1, since the first and second waveguides are formed as a same waveguide, the first and second waveguides are collectively called as a first waveguide (waveguide 101).

The photonic crystal 100 has a structure having a three-dimensional periodic refractive index distribution, in other words, a structure where a first medium and a second medium having a smaller refractive index than that of the first medium are periodically arranged. The photonic crystal 100 has a complete photonic band gap.

The waveguide 101 has a structure constituted by providing a line defect in the photonic crystal 100. The provision of the line defect in the photonic crystal 100 enables production of a state where light in a certain frequency band of light in frequency bands included in the complete photonic band gap of the photonic crystal 100 can exist in the line defect. Further, the provision of the line defect in the photonic crystal 100 causes light to propagate therein in a direction in which the line defect extends. The light propagating in the line defect has a unique electromagnetic energy distribution according to the structure of the photonic crystal or the structure of the line defect. A guide mode of the light propagating in the waveguide 101 is defined as a guide mode 1 (first guide mode).

The guide mode means a state of light propagating with a unique electromagnetic energy distribution, which is determined by a structure of a waveguide in which the light propagates. A unique electromagnetic energy distribution in a certain guide mode is referred to as a guide mode pattern. A frequency of light propagating with a unique electromagnetic energy distribution is referred to as a guide mode frequency.

The output region 102 has a structure different from that of the waveguide 101. In the output region 102, light propagates in a guide mode different from the guide mode 1 of the light propagating in the waveguide 101. The output region 102 can be formed by, for example, providing a defect different from the waveguide 101 in the photonic crystal 100. The output region 102 can be formed by using a photonic crystal different from the photonic crystal 100. Further, the output region 102 may be a region where a medium such as air is spatially homogeneously distributed, or a region where a thin line waveguide is provided. A guide mode of light propagating in the output region 102 is defined as a guide mode 3 (third guide mode).

A band of the guide mode frequency of the light propagating in the waveguide 101 and a band of the guide mode frequency of the light propagating in the output region 102 include a same frequency band at least in parts thereof.

The waveguide 101 and the output region 102 are connected with each other via a connection portion 104.

The three-dimensional structure A further includes a reflective portion 103. The reflective portion 103 is formed by providing a defect in part of the line defect forming the waveguide 101. The reflective portion 103 is formed as a defect which is formed of a medium having a refractive index different from that of a medium forming the line defect that is the waveguide 101. The reflective portion 103 has a homogeneous refractive index distribution (that is, a same refractive index) over the entire section orthogonal to the direction in which the line defect forming the waveguide 101 extends.

In description below, the direction in which the waveguide (line defect) extends or a direction in which light propagates is referred to as a guide direction (or propagation direction). This applies to other embodiments described below.

A shape and a size (dimensions) of a section, which is orthogonal to the guide direction, of the reflective portion 103 are equal to those of a section, which is orthogonal to the guide direction and contacts the section of the reflective portion 103, of the waveguide 101.

The equal shapes and equal sizes mean not only a case where shapes and sizes are completely equal but also a case where shapes and sizes can be regarded as equal while a slight difference therebetween is present within a range of manufacturing errors. This applies to other embodiments described below.

In the three-dimensional structure A shown in FIG. 1, input light entering from an input portion 105 propagates in the waveguide 101 toward the connection portion 104 in the guide mode 1. When the light propagating in the waveguide 101 reaches the reflective portion 103, its guide mode pattern is disturbed. In this case, since the photonic crystal 100 disposed around the reflective portion 103 has a complete photonic band gap, there is no light propagating in a radiation mode. Thus, even if the guide mode pattern of the light propagating in the waveguide 101 is disturbed by the reflective portion 103, the light propagating in the guide mode 1 can be prevented from being coupled with light propagating in the radiation mode to become a loss.

When the reflective portion 103 disturbs the guide mode pattern of the light propagating in the waveguide 101, part of the light is coupled with light propagating in the waveguide 101 in the guide mode 1 toward an input portion 105. The other part of the light is coupled with light propagating in the waveguide 101 in the guide mode 2 toward the connection portion 104. In other words, part of the light propagating in the waveguide 101 is reflected by the reflective portion 103, while the other part of the light is transmitted therethrough. The light transmitted through the reflective portion 103 is referred to as a transmitted wave 106. A reflectance of the reflective portion 103 can be controlled by changing at least one of a shape, a medium and a position of the reflective portion 103.

Specifically, since most part of energy of the light propagating in the waveguide 101 concentrates in the line defect, providing the reflective portion 103 in the waveguide 101 which is the line defect can significantly disturb the guide mode pattern of the light propagating in the waveguide 101. As a result, according to at least one of the shape, the medium and the position of the reflective portion 103, the reflectance of the reflective portion 103 can be controlled to an arbitrary value.

Further, since providing the reflective portion 103 in the line defect (first waveguide) does not disturb the structure of the photonic crystal 100, an optical confinement effect obtained by the complete photonic band gap is prevented from being changed due to the provision of the reflective portion 103.

Moreover, the reflective portion 103 has a shape providing a homogeneous refractive index distribution over the entire section orthogonal to the direction (guide direction) in which the waveguide (line defect) 101 extends. This makes it unnecessary to adjust the shape of the reflective portion 103 in the section orthogonal to the guide direction, enabling easy manufacturing of the reflective portion 103. Such a shape of the reflective portion 103 enables easy control of the reflectance of the reflective portion 103 only by adjusting a length of the reflective portion 103 in the guide direction.

Part of the light entering from the input portion 105 to propagate in the waveguide 101 is transmitted through the reflective portion 103 and then propagates in the waveguide 101 toward the connection portion 104. The light propagating in the waveguide 101 toward the connection portion 104 is coupled with light propagating in the output region 102 in the guide mode 3 through the connection portion 104.

The guide mode 1 of the light propagating in the waveguide 104 and the guide mode 3 of the light propagating in the output region 102 are mutually different guide modes. Thus, part of the light that has reached the connection portion 104 is coupled with the light propagating in the waveguide 101 toward the reflective portion 103. In other words, part of the light that has reached the connection portion 104 is reflected by the connection portion 104. The reflected light propagates in the waveguide 101 and repeats reflection at the reflective portion 103, propagation in the waveguide 101 and reflection at the connection portion 104. Of such a reflected wave, light propagating in the waveguide 101 toward the connection portion 104 is referred to as a reflected wave 107.

The transmitted wave 106 and the reflected wave 107 mutually interfere to become light propagating in the waveguide 101 toward the connection portion 104. In the input light entering from the input portion 105 and propagating in the waveguide 101, light which is not coupled with an interfered wave of the transmitted wave 106 and the reflected wave 107 is reflected to return to the input portion 105. This light is not output to the output region 102 but becomes a loss. In description below, light which is part of the input light entering from the input portion 105 and which is not output to the output region 102 but returns to the input portion 105 to become a loss is referred to as returning light 108.

If the transmitted and reflected waves 106 and 107 mutually interfere in a state where their phases are different from each other by an integral multiple of 2π, the transmitted and reflected waves 106 and 107 reinforce each other. As a result, intensity I108 of the returning light 108 is reduced. An influence of the interference increases as amplitudes of the transmitted and reflected waves 106 and 107 are more equal to each other, reducing the intensity of the returning light 108. The reduced intensity of the returning light 108 increases intensity of the light propagating in the waveguide 101 toward the connection portion 104, which results in higher intensity of the light output to the output region 102. In other words, the coupling efficiency of the light propagating in the waveguide 101 in the guide mode 1 and the light propagating in the output region 102 in the guide mode 3 can be improved.

The intensity I108 of the returning light 108 can be represented by the following expression 1:

$$I 108 = 1 - [ \frac{( 1 - R 103 ) \cdot ( 1 - R 104 )}{\begin{matrix}1 + R 103 \cdot R 104 - \\ 2 \cdot \sqrt{R 103 \cdot R 104} cos ( Φ )\end{matrix}} ] \\ Φ = φ 103 + φ 104 + 2 {k}_{s} L 1 \qquad [ Expression 1 ]$$

In the expression 1, R103 denotes a power reflectance when the light propagating in the waveguide 101 in the guide mode 1 is reflected by the reflective portion 103. φ103 denotes a phase amount, which is changed by reflection at the reflective portion 103, of the light propagating in the waveguide 101 in the guide mode 1. R104 denotes a power reflectance when the light propagating in the waveguide 101 in the guide mode 1 is reflected by the connection portion 104. φ104 denotes a phase amount, which is changed by reflection at the connection potion 104, of the light propagating in the waveguide 101 in the guide mode 1. Kz denotes a size of a wave vector, in a direction parallel to the guide direction, of the light propagating in the waveguide 101 in the guide mode 1. L1 denotes a length of the waveguide 101 from the reflective portion 103 to the connection portion 104.

Conditions where the intensity I108 of the returning light 108 is minimum, that is, conditions to be satisfied to reduce the returning light 108 can be derived from the expression 1, which are represented by the following expressions 2 and 3:

Φ=φ103+φ104+2k_{z}L1=2nπ(n is an arbitrary integer) [Expression 2]

R103=R104 [Expression 3]

The expression 2 is a conditional expression relating to a phase of the light propagating in the waveguide 101. A sum of a phase amount 2·Kz·L1 which is provided by propagation of the light in the waveguide 101 between the reflective portion 103 and the connection portion 104 and the phase amounts φ103 and φ104 which are changed by reflections at the reflective portion 103 and the connection portion 104 is defined as a phase amount Φ. Symbol n denotes an arbitrary integer. The expression 3 is a conditional expression relating to an amplitude of the light propagating in the waveguide 101. Designing the structure of the reflective portion 103 so as to satisfy the expressions 2 and 3 enables reduction of the returning light 108.

In the expression 2, the phase amount φ104 changed by the reflection at the connection portion 104 is determined by the structures of the waveguide 101 and the output region 102, a positional relationship thereof, and a distance therebetween. The phase amount φ103 changed by the reflection at the reflective portion 103 is determined by a shape and a position of the reflective portion 103, and a medium forming the reflective portion 103. A length L1 of the waveguide 101 between the reflective portion 103 and the connection portion 104 is determined by the position of the reflective portion 103. An appropriate position of the reflective portion 103 enables control of the length L1 of the waveguide 101 between the reflective portion 103 and the connection portion 104.

The condition of the expression 2 shows that the intensity of the returning light 108 can be more reduced as the phase amount Φ is a value more similar to an integral multiple of 2π. In other words, changing the position of the reflective portion 103 to set the length L1 of the waveguide 101 between the reflective portion 103 and the connection portion 104 enables control of a value of the phase amount Φ, thereby satisfying the condition of the expression 2. Changing the shape of the reflective portion 103 and the medium forming the reflective portion 103 enables setting of the phase amount φ103 changed by the reflection at the reflective portion 103 to an appropriate value. Thus, a value of the phase amount Φ can be controlled so as to satisfy the condition of the expression 2.

In the expression 3, the reflectance R104 of the connection portion 104 is determined by the structures of the waveguide 101 and the output region 102, a positional relationship thereof, and a distance therebetween. The reflectance R103 of the reflective portion 103 is determined by a shape and a position of the reflective portion 103, and a medium forming the reflective portion 103. The condition of the expression 3 shows that the intensity of the returning light 108 can be more reduced as the reflectances of the reflective portion 103 and the connection portion 104 are more similar to each other (preferably matched).

Changing the shape the position of the reflective portion 103, and the medium forming the reflective portion 103 enables control of the reflectance R103 of the reflective portion 103, thereby satisfying the condition of the expression 3.

Satisfying the conditions of the expressions 2 and 3 enables suppression of the returning light 108, thereby reducing a loss. Moreover, suppressing the returning light 108 to increase the intensity of the light output to the output region 102 enables improvement of the coupling efficiency of the light propagating in the waveguide 101 in the guide mode 1 and the light propagating in the output region 102 in the guide mode 3.

Satisfying the conditions of the expressions 2 and 3 is ideal. However, if the reflectance R103 and the phase amount Φ of the reflective portion 103 satisfy conditions of expressions 4 and 5, a sufficient suppression effect of the returning light 108 and an improving effect of the coupling efficiency can be obtained.

cos(Φ)≧cos(25°) [Expression 4]

R104−0.30≦R103≦R104+0.20 [Expression 5]

The expressions 4 and 5 can be rewritten into the following general forms:

Φ=φ1+φ2+2K_{z}L

cos(Φ)≧cos 25°

R2−0.30≦R1≦R2+0.20.

R1 and φ1 are respectively equivalent to the reflectance R103 and the phase amount φ103 of the reflective portion 103. R2 and +2 are respectively equivalent to the reflectance R104 and the phase amount φ104 of the connection portion 104. L is equivalent to the length L1 of the waveguide 101 between the reflective portion 103 and the connection portion 104.

More preferably, the reflective portion 103 is provided to satisfy conditions of expressions 6 and 7. In the expressions 4 and 6, the reflectance R103 of the reflective portion 103 has a value from 0.0 to 1.0 irrespective of a size of the reflectance R104 of the connection portion 104. The reflectance R103 of the reflective portion is preferably set to a value equal to or less than that of the reflectance R104 of the connection portion 104. Thus, a change in intensity of a returning light can be reduced with respect to a change of the phase amount Φ.

cos(Φ)≧cos(15°) [Expression 6]

R104−0.20≦R103≦R104+0.10 [Expression 7]

A reduction amount of the intensity of the returning light can be arbitrary set. In this case, a conditional expression for the reflective portion 103 can be derived from the expression 1. The reflectance R103 and the phase amount Φ of the reflective portion 103 preferably satisfy conditions of expressions 8 and 9 to reduce the intensity of the returning light to a level less than a half of that when no reflective portion 103 is provided.

cos(Φ)>cos [42×(1−R104)] [Expression 8]

0.5×R104²≦R103≦R104+0.15 [Expression 9]

More preferably, for the reflectance R103 and the phase amount Φ of the reflective portion 103, the intensity of the returning light is preferably less than ⅓ when no reflective portion is provided. Thus, the reflective portion 103 is provided so as to satisfy conditions of expressions 10 and 11.

cos(Φ)>cos [35×(1−R104)] [Expression 10]

0.8×R104²≦R103≦R104+0.12 [Expression 11]

### Embodiment 2

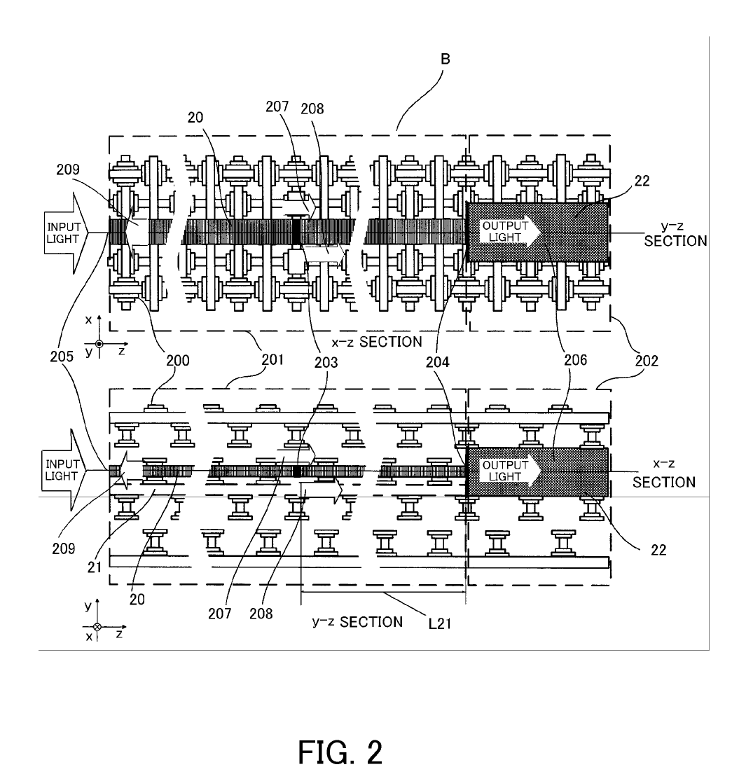

FIG. 2 shows a schematic configuration of a three-dimensional structure B including an anti-reflection structure, which is Embodiment 2 of the present invention. The three-dimensional structure B includes a waveguide (first waveguide) 201 and a reflective portion 203 in a three-dimensional photonic crystal structure (hereinafter simply referred to as a photonic crystal) 200.

In this embodiment, a left waveguide with respect to the reflective portion 203 in FIG. 2 is also referred to as a first waveguide, and a right waveguide formed between the reflective portion 203 and a first region 202 described below is also referred to as a second waveguide. However, in Embodiment 2, since the first and second waveguides are formed as a same waveguide, the first and second waveguides are collectively called as a first waveguide (waveguide 201).

The waveguide 201 is formed by providing a line defect in the photonic crystal 200. The reflective portion 203 is formed by providing a defect in part of the line defect of the waveguide 201. The reflective portion 203 is formed of a medium having a refractive index different from that of a medium forming the line defect that is the waveguide 201.

The three-dimensional structure B further includes an output region 202 that is the first region. The output region 202 includes a waveguide (third waveguide) 206 in the photonic crystal 200. The waveguide 206 is formed by providing a line defect in the photonic crystal 200. The waveguides 201 and 206 have structures mutually different, and are connected with each other via a connection portion 204.

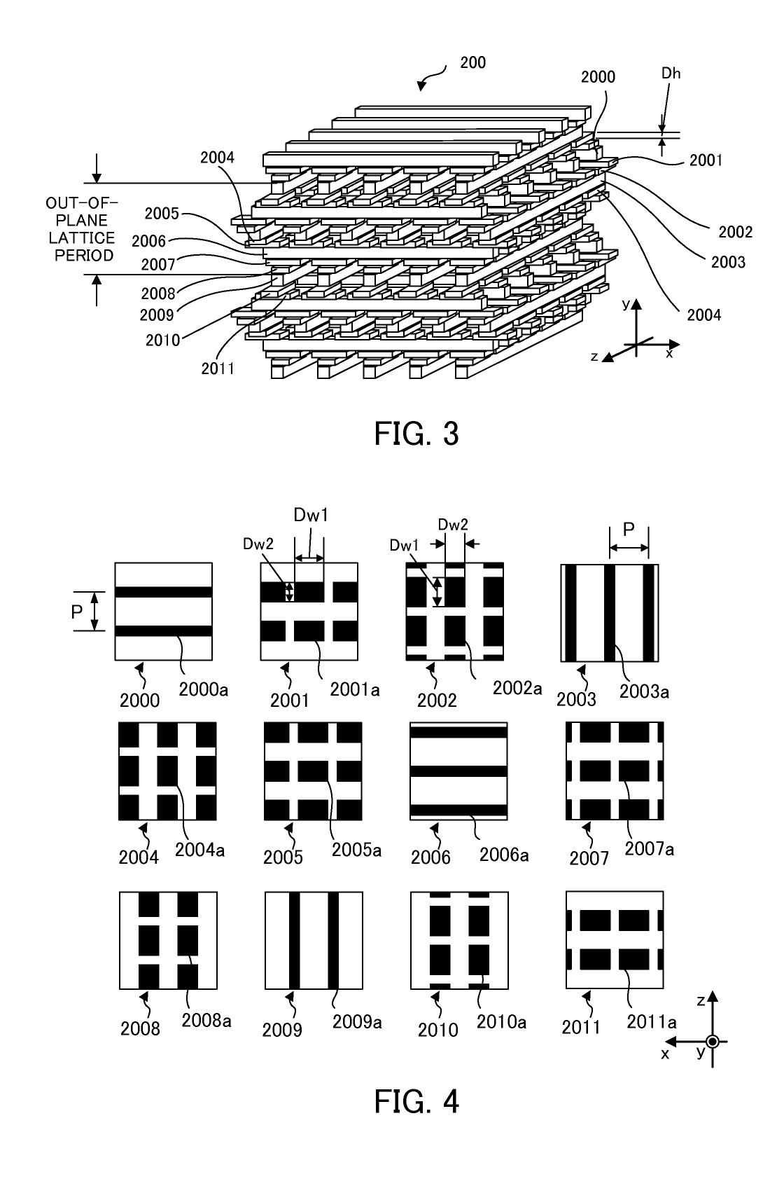

FIG. 3 shows a schematic structure of the photonic crystal 200 having a photonic band gap. The three-dimensional photonic crystal 200 is constructed based on a basic period of 12 layers 2000 to 2011 including an x-z plane.

FIG. 4 shows part of an x-z section (viewed in a y-axis direction) of each of the layers 2000 to 2011. Each of first and seventh layers 2000 and 2006 as columnar structure layers includes columnar structures (first columnar structures) 2000a and 2006a which extend in an x-axis direction (first direction) and are arranged at equal intervals P in a z-axis direction. The columnar structures 2000a and 2006a are shifted from each other by P/2 in the z-axis direction.

Each of fourth and tenth layers 2003 and 2009 as columnar structure layers includes columnar structures (second columnar structures) 2003a and 2009a which extend in the z-axis direction (second direction) orthogonal to the x-axis direction and are arranged at equal intervals P in the x-axis direction. The columnar structures 2003a and 2009a are shifted from each other by P/2 in the x-axis direction.

In other words, the photonic crystal 200 has a basic structure where the columnar structure layers (first and seventh layers) having the columnar structures extending in the x-axis direction and the columnar structure layers (fourth and tenth layers) having the columnar structures extending in the z-axis direction are alternately stacked.

Second and third layers 2001 and 2002 which are additional layers are disposed between the first and fourth layers 2000 and 2003 which are the columnar structure layers. The second and third layers 2001 and 2002 respectively include discrete structures 2001a and 2002a arranged at positions corresponding to intersection points between the columnar structures 2000a and 2003a in the first and fourth layers 2000 and 2003 when viewed in the y-axis direction. The discrete structures 2001a and 2002a have a rectangular plate shape, respectively, and are discretely arranged so as not to contact each other in the x-z plane in the second and third layers 2001 and 2002.

The discrete structures 2001a and 2002a have rectangular plate shapes where one of them is rotated by 90° in the x-z plane to be stacked on the other.

Further, fifth and sixth layers 2004 and 2006, eighth and ninth layers 2007 and 2008, and eleventh and twelfth layers 2010 and 2011 as additional layers are respectively arranged between the fourth and seventh layers 2003 and 2006, between the seventh and tenth layers 2006 and 2009, and between the tenth layer 2009 and a first layer of a next basic period. The fifth and sixth layers 2004 and 2005, the eighth and ninth layers 2007 and 2008, and the eleventh and twelfth layers 2010 and 2011 are formed, as in the second and third layers 2001 and 2002. In other words, discrete structures 2004a, 2005a, 2007a, 2008a, 2010a, and 2011a are arranged at positions corresponding to intersection points between the columnar structures in the columnar structure layers including the columnar structures extending in the directions orthogonal to each other when viewed in the y-axis direction.

In the columnar structure layer and the additional layer adjacent thereto, the columnar structure and the discrete structure are in contact with each other. Appropriate setting of structural parameters such as refractive indexes, shapes and intervals of materials forming the columnar structure and the discrete structure, and a thickness of each layer enables acquisition of a complete photonic band gap in a specific broad frequency band (wavelength band).

In such a photonic crystal 200, a defect which disturbs the period of the photonic crystal 200 generates light of a defect mode having a frequency in the complete photonic band gap. This defect mode is a mode where its frequency (wavelength) and its wave vector are determined depending on a shape or a medium of the defect.

In Embodiment 2, the waveguides 201 and 206 are configured so as to have guide modes mutually different in the complete photonic band gap of the photonic crystal 200.

In the three-dimensional structure B, the waveguides 201 and 206 are connected with each other via the connection portion 104. A center coordinate of a section (first section) of a first line defect 20 forming the waveguide 201, the first section being orthogonal to the z-axis direction (guide direction) in which the first line defect 20 extends, matches a center coordinate of a section (second section) of a second line defect 22 forming the waveguide 206, the second section being orthogonal to a direction in which the second line defect 22 extends.

The reflective portion 203 is formed by providing a defect in the first line defect 20 forming the waveguide 201.

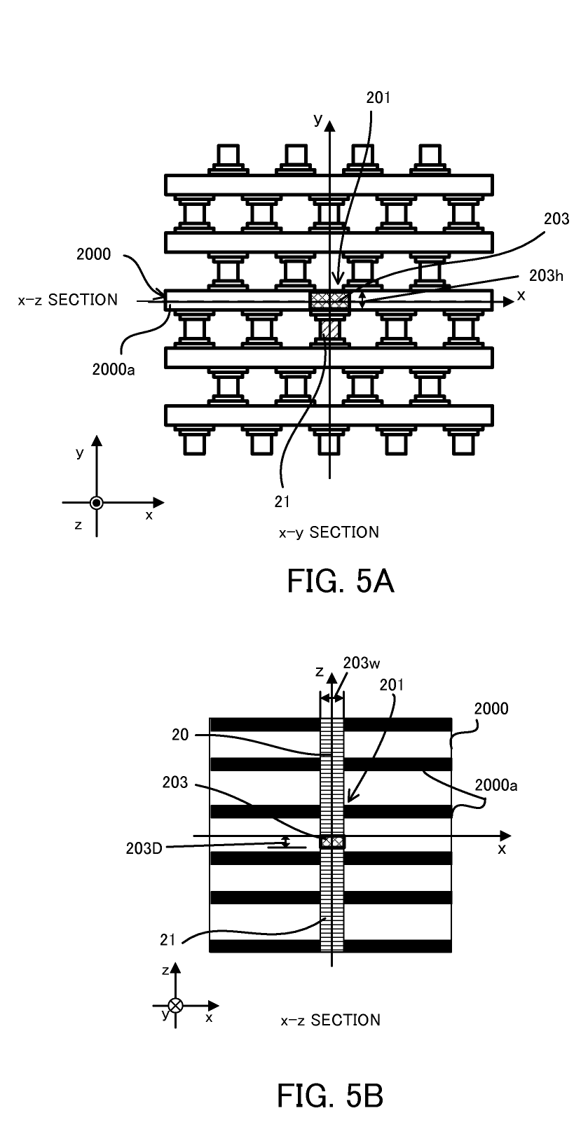

FIG. 5A shows an x-y section of the reflective portion 203, and FIG. 5B shows an x-z section of the reflective portion 203.

Also in Embodiment 2, a shape and a size of a section, which is orthogonal to the guide direction, of the reflective portion 203 are equal to those of the section, which is orthogonal to the guide direction and contacts the section of the reflective portion 203, of the waveguide 201. The reflective portion 203 has a homogeneous refractive index in the entire section orthogonal to the guide direction.

Since most part of energy of the light propagating in the waveguide 201 concentrates in the line defect, providing the reflective portion 203 in the waveguide 201 significantly disturb the guide mode pattern of the light propagating in the waveguide 201. As a result, according to the shape, the medium and the position of the reflective portion 203, a reflectance of the reflective portion 203 can be greatly changed, which makes it possible to control the reflectance to an arbitrary value.

Further, since providing the reflective portion 203 in the waveguide 201 does not disturb the structure of the photonic crystal 200, an optical confinement effect obtained by the complete photonic band gap is prevented from being changed due to the provision of the reflective portion 203.

Moreover, the reflective portion 203 has a homogeneous refractive index distribution in the section orthogonal to the guide direction. This makes it unnecessary to adjust the shape of the reflective portion 203 in the section orthogonal to the guide direction, enabling easy manufacturing of the reflective portion 203. Therefore, the reflectance of the reflective portion 203 can be easily controlled only by adjusting a length of the reflective portion 203 (reflective portion length) in a direction parallel to the guide direction.

In FIG. 2, when light entering from the input portion 205 to propagate in the waveguide 201 in the guide mode 1 enters the reflective portion 203, as described in Embodiment 1, the guide mode pattern of the light is disturbed. The photonic crystal 200 which is present around the reflective portion 203 has the complete photonic band gap, and therefore no radiation mode exists. Thus, the light propagating in the waveguide 201 can be prevented from being coupled with light propagating in a radiation mode to become a loss.

Part of the light which propagates in the waveguide 201 and whose guide mode pattern is disturbed by the reflective portion 203 becomes a transmitted wave propagating in the waveguide 201 toward the connection portion 204. Such a transmitted wave generated by the reflective portion 203 is referred to as a transmitted wave 207. Part of the light transmitted through the reflective portion 203 is multiply-reflected between the reflective portion 203 and the connection portion 204. Of such a reflected wave, light propagating in the waveguide 201 toward the connection portion 204 is referred to as a reflected wave 208.

The transmitted wave 207 and the reflected wave 208 mutually interfere to become light propagating in the waveguide 201 toward the connection portion 204. In the input light entering from the input portion 205 and propagating in the waveguide 201, light which is not coupled with an interfered wave of the transmitted wave 207 and the reflected wave 208 is reflected to return to the input portion 205. This light is not output to the output region 202 but becomes a loss. Of such light in a defect mode, light which is not output to the output region 202 but returns to the input portion 205 to become a loss is referred to as returning light 209. Intensity of the returning light 209 is denoted by I209.

The intensity I209 of the returning light 209 is represented by the expression 1 as in Embodiment 1. Further, as in Embodiment 1, satisfying the conditions of the expressions 4 and 5 (ideally satisfying the conditions of the expressions 2 and 3) enables reduction of the intensity I209 of the returning light 209, thereby suppressing a loss. The reduced intensity I209 of the returning light 209 increases intensity of the light propagating in the waveguide 201 toward the connection portion 204. As a result, intensity of light output to the output region 202 is increased. In other words, the coupling efficiency of the light propagating in the waveguide 201 in the guide mode 1 and the light propagating in the output region 202 in the guide mode 3 can be improved.

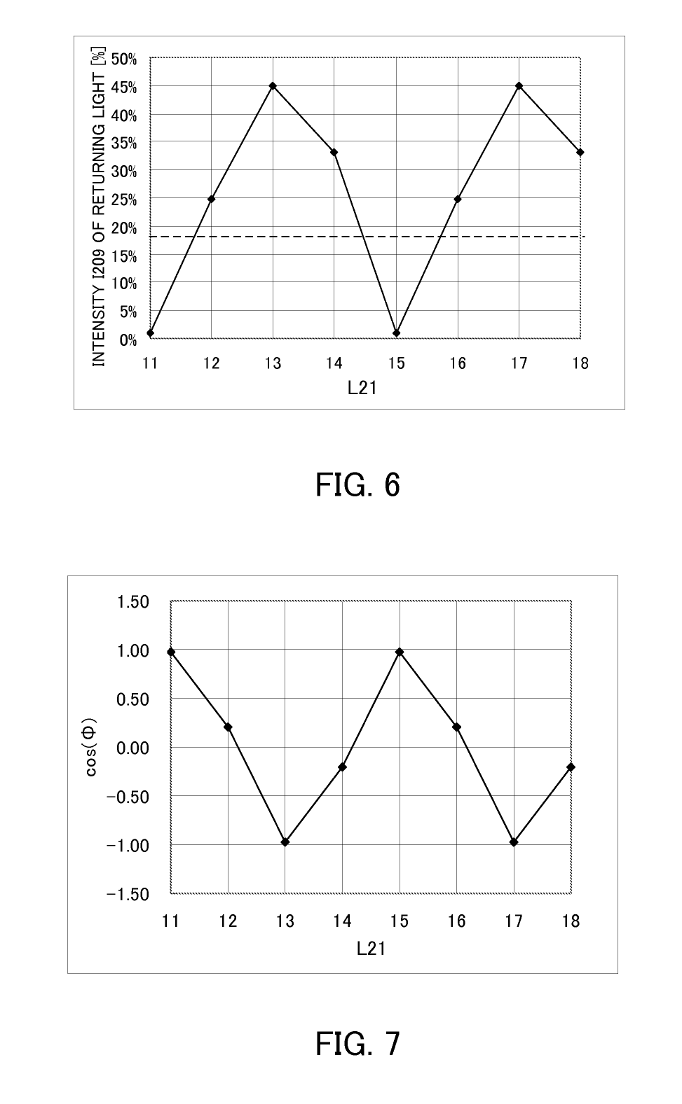

FIG. 6 is a graph showing calculation results of the intensity I209 of the returning light 209 in the three-dimensional structure B when a length 203D of the reflective portion 203 is 0.20P and a length L21 of the waveguide 201 between the reflective portion 203 and the connection portion 204 is changed, the calculation being performed using a transfer matrix method (TMM). In the graph of FIG. 6, a horizontal axis indicates the length L21 normalized by a lattice period P, and a vertical axis indicates the intensity I209 of the returning light 209 when the intensity of the input light is 1.

In FIG. 6, a broken line indicates the intensity of the returning light 209 when no reflective portion 203 is provided.

FIG. 7 is a graph showing calculation results of the phase amount Φ when the length 203D of the reflective portion 203 is set to 0.20P and the length L21 of the waveguide 201 between the reflective portion 203 and the connection portion 204 is changed, the calculation being performed using the TMM. In FIG. 7, a horizontal axis indicates the length L21 normalized by the lattice period P, and a vertical axis indicates cosine values of the phase amount Φ (cos(Φ)).

In FIG. 6, the intensity I209 of the returning light 209 is reduced to a lower level than the intensity indicated by the broken line when the length L21 is around 11P and 15P. In other words, setting the length L21 to 11P or 15P or close thereto enables reduction of the returning light 209 to a lower level than when no reflective portion 103 is provided.

Further, in FIG. 7, when the length L21 is around 11P and 15P, cos(Φ) approaches 1. In other words, setting the length L21 to 11P or 15P or close thereto causes the phase amount Φ to be an integral multiple of 2π or a value close thereto. Comparison of FIGS. 6 and 7 clearly shows that the intensity I209 of the returning light 209 reduces as the phase amount Φ approaches an integral multiple of 2π. In other words, satisfying the condition of the expression 4 (or the expression 2) reduces the intensity I209 of the returning light 209. Thus, changing the length L21 of the waveguide 201 between the reflective portion 203 and the connection portion 204 to control the phase amount Φ enables reduction of the intensity I209 of the returning light 209.

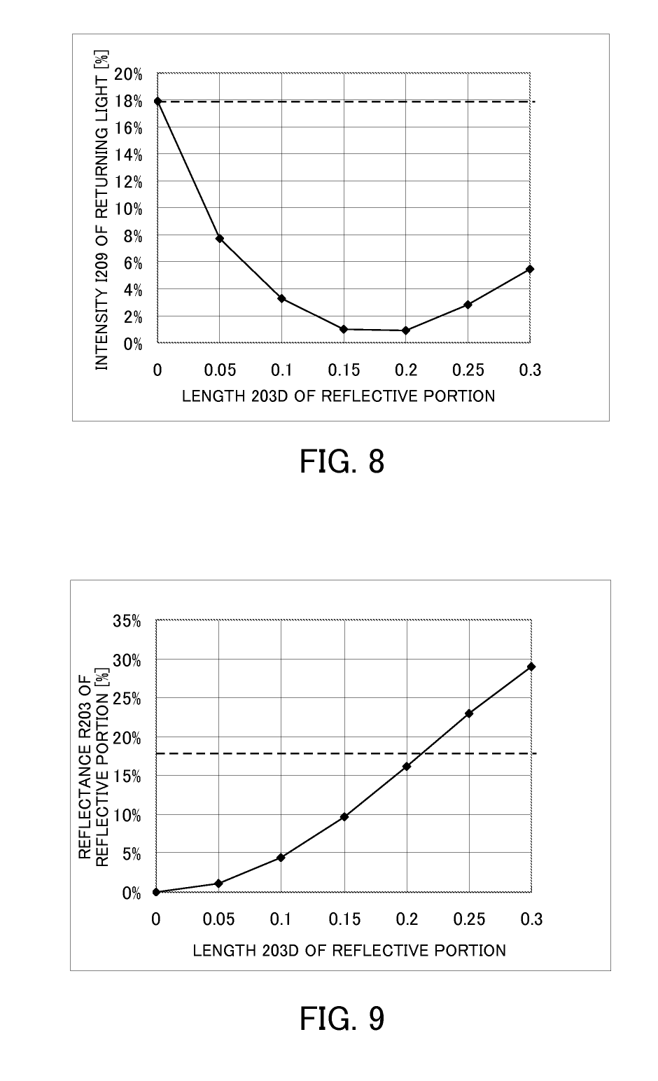

FIG. 8 is a graph showing calculation results of the intensity I209 of the returning light 209 in the three-dimensional structure B when the length L21 is set to 11P and the length (defect length) 203D of the reflective portion 203 is changed to change a reflectance R203 of the reflective portion 203, the calculation being performed using the TMM. In the graph of FIG. 8, a horizontal axis indicates the length 203D of the reflective portion 203 normalized by the lattice period P, and a vertical axis indicates the intensity I209 of the returning light 209 when the intensity of the input light is 1.0. In FIG. 8, a broken line indicates the intensity of the returning light 209 when no reflective portion 203 is provided.

FIG. 9 is a graph showing calculation results of the reflectance R203 of the reflective portion 203 in the three-dimensional structure B when the length L21 is set to 11P and the length 203D of the reflective portion 203 is changed, the calculation being performed using the TMM. In FIG. 9, a horizontal axis indicates the length 203D of the reflective portion 203 normalized by the lattice period P, and a vertical axis indicates the reflectance R203 of the reflective portion 203. In FIG. 9, a broken line indicates a reflectance when no reflective portion 203 is provided.

In FIG. 8, the intensity I209 of the returning light 209 is changed by changing the length 203D of the reflective portion 203 and thereby is reduced to a lower level than the intensity indicated by the broken line. In other words, providing the reflective portion 203 enables reduction of the returning light 209 to a lower level than when no reflective portion 203 is provided. It can be understood that the intensity I209 of the returning light 209 is reduced to the lowest level when the length 203D of the reflective portion 203 is around 0.20P.

Further, as shown in FIG. 9, when the length 203D of the reflective portion 203 is around 0.20P, the reflectance R203 of the reflective portion 203 approaches a reflectance of the connection portion 204 (which is indicated by the broken line) when no reflective portion 203 is provided.

In other words, as shown in FIG. 8, the intensity I209 of the returning light 209 reduces as the reflectance R203 of the reflective potion 203 approaches the reflectance of the connection portion 204. Thus, satisfying the condition of the expression 5 (or the expression 3) enables reduction of the intensity I209 of the returning light 209.

Moreover, satisfying the condition of the expression 5 (or the expression 3) by changing the length 203D of the reflective portion 203 so as to control the reflectance R203 of the reflective portion 203 enables reduction of the intensity I209 of the returning light 209.

Thus, providing the reflective portion 203 so as to satisfy the conditions of the expressions 4 and 5 (ideally, so as to satisfy the conditions of the expressions 2 and 3) enables reduction of the intensity of the returning light 209.

The reduced intensity of the returning light 209 increases intensity of the light propagating in the waveguide 201 toward the connection portion 204. As a result, intensity of the light output to the output region 202 is increased. In other words, the coupling efficiency of the light propagating in the waveguide 201 in the guide mode 1 and the light propagating in the output region 202 in the guide mode 3 can be improved.

The description in this embodiment was made of the three-dimensional photonic crystal which has a woodpile structure including the additional layers. However, a waveguide may be formed by using a three-dimensional photonic crystal which has a woodpile structure including no additional layer. A waveguide may be formed by using a three-dimensional photonic crystal having a structure other than the woodpile structure.

The waveguide may be a straight waveguide or a curved waveguide.

Further, it is preferable in applications of the three-dimensional structure to devices that the first waveguide (and the second waveguide) be formed so as to cause light to propagate therein in a single guide mode.

### Embodiment 3

Next, a three-dimensional structure C including an anti-reflection structure, which is Embodiment 3 of the present invention will be described. In Embodiment 3, description will be made of a three-dimensional structure including a waveguide different from the waveguide 206 shown in FIG. 2.

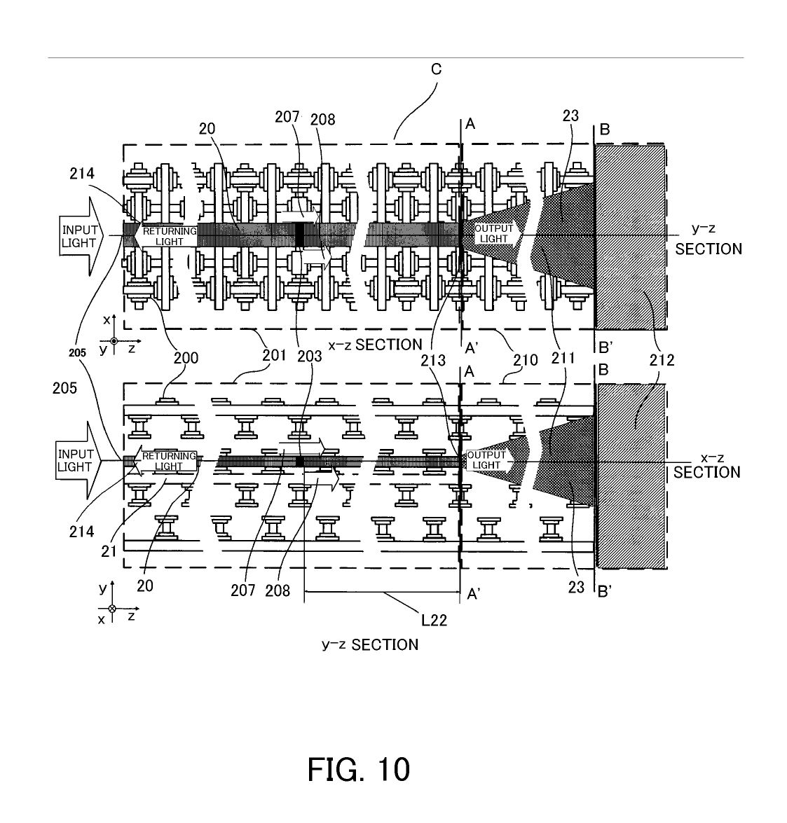

FIG. 10 shows a schematic configuration of the three-dimensional structure C. The three-dimensional structure C includes a waveguide 201 and a reflective portion 203 in a photonic crystal 200. In Embodiment 3, the photonic crystal 200, the waveguide 201 and the reflective portion 203 have same structures as those in Embodiment 2.

A first output region (first region) 210 includes a waveguide 211 formed by providing a tapered line defect in the photonic crystal 200. A second output region (second region) 212 is formed of a spatially homogeneous medium (e.g., air).

The waveguide 211 included in the first output region 210 has a structure different from that of the waveguide 201, and is connected with the waveguide 201 via a connection portion 213. The waveguide 211 is connected with the second output region 212.

A line defect 23 is formed into a tapered shape whose width in an x-y plane and thickness gradually increase from a position of a section A-A′ to a position of a section B-B′.

The line defect 23 is formed of a medium having a same refractive index (defect refractive index) as that of a medium (first medium) forming columnar structures included in the photonic crystal 200.

A center coordinate of a section (first section) of the line defect 23 forming the waveguide 211 in the first output region 210, the first section being orthogonal to a z-axis direction (guide direction) in which the line defect 23 extends, matches a center coordinate of a section (second section) of a line defect 20 forming the waveguide 201, the second section being orthogonal to the guide direction.

When the waveguides 201 and 211 are connected with each other, part of light propagating in the waveguide 201 in the guide mode 1 is coupled with light propagating in the waveguide 211 in the guide mode 2 to propagate in the waveguide 211. The light propagating in the waveguide 211 in a guide mode 3 is coupled with light propagating in the second output region 212 connected to the waveguide 211 in a guide mode 4 different from the guide modes 1 and 3 to be emitted to the second output region 212.

A guide mode pattern of the light propagating in the waveguide 211 is enlarged as it propagates from the section A-A′ to the section B-B′, and emitted to the second output region 212 at a spread angle according to a size of the guide mode pattern. Appropriately designing the tapered line defect 23 enables emission of light having a predetermined spread angle and a predetermined intensity distribution to the second output region 212.

Providing a structure (emission pattern control structure) including such a tapered line defect 23 at an end of the waveguide 201 in the photonic crystal 200 enables acquisition of a light-emitting device whose emission pattern is controlled.

In addition, approximating the guide mode pattern in the emission pattern control structure to a guide mode pattern of the second output region 212 formed by a fiber or a thin-line waveguide enables improvement of the coupling efficiency between the emission pattern control structure and the second output region 212.

Providing such an emission pattern control structure at the end of the waveguide 201 in the photonic crystal 200 generates a reflected wave in a connection portion of the waveguide 201 with the emission pattern control structure.

In contrast thereto, in Embodiment 3, appropriately providing the reflective portion 203 in the waveguide 201 suppresses a loss caused by such a reflected wave. Suppressing the loss caused by the reflected wave enables improvement of the coupling efficiency of the light propagating in the waveguide 201 in the guide mode 1 and the light propagating in the waveguide 211 in the guide mode 4.

In the three-dimensional structure C, when input light of a normalized frequency of 0.491 enters from an input portion 205, part of the light propagating in the waveguide 201 is not output to the first output region 210 but returns to the input potion 205 to become a loss. Such light is referred to as returning light 214. Intensity of the returning light 214 is denoted by I214.

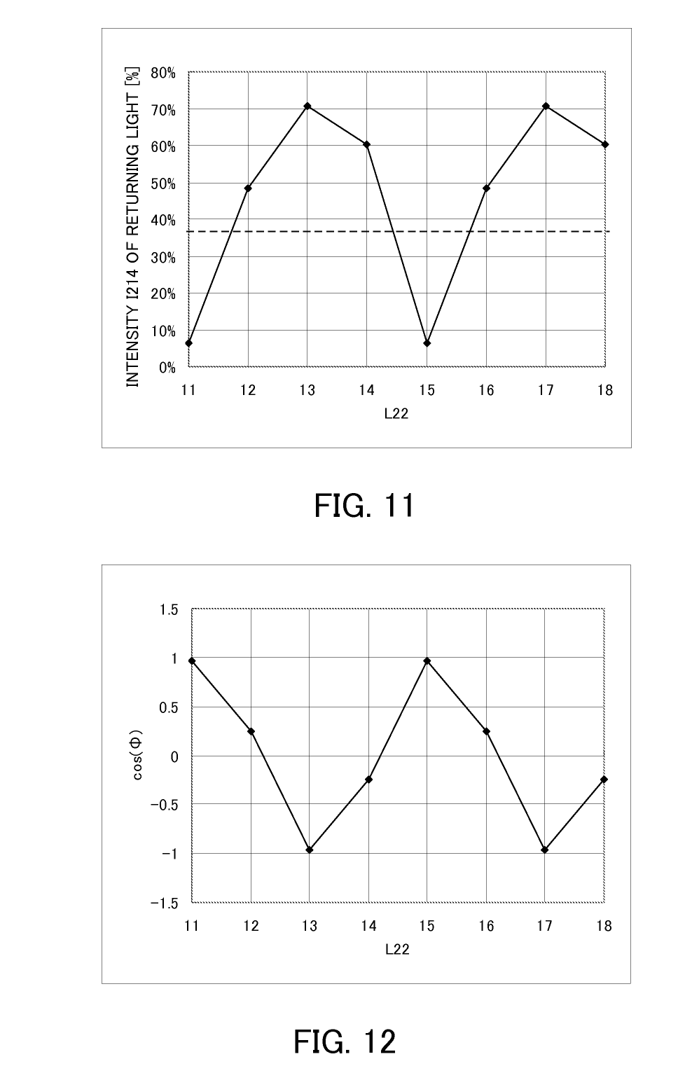

FIG. 11 is a graph showing calculation results of the intensity I214 of the returning light 214 in the three-dimensional structure C when a length (defect length) 203D of the reflective portion is set to 0.25P and a length L22 of the waveguide 201 between the reflective portion 203 and the connection portion 213, the calculation being performed by using the TMM. In the graph of FIG. 11, a horizontal axis indicates the length L22 normalized by the lattice period P, and a vertical axis indicates the intensity I214 of the returning light 214.

In FIG. 11, a broken line indicates the intensity of the returning light 214 when no reflective portion 203 is provided. As indicated by the broken line, when no reflective portion 203 is provided, light with an intensity of 36.74% in the input light is reflected on the connection portion 213 to become a loss.

FIG. 12 is a graph showing calculation results of a phase amount Φ in the three-dimensional structure C when the length 203D of the reflective portion 203 is set to 0.25P and the length L22 of the waveguide 201 between the reflective portion 203 and the connection portion 213 is changed, the calculation being performed by using the TMM. In FIG. 12, a horizontal axis indicates the length 22L normalized by the lattice period P, and a vertical axis indicates cosine values of the phase amount Φ (cos(Φ)).

In FIG. 11, the intensity I214 of the returning light 214 is reduced to a lower level than the intensity indicated by the broke line when the length L22 is around 11P and 15P. In other words, setting the length L22 to 11P or 15P or close thereto enables reduction of the returning light 214 to a lower level than when no reflective portion 203 is provided.

Further in FIG. 12, when the length L22 is around 11P and 15P, cos(Φ) approaches 1. In other words, when the length L22 is 11P or 15P or close thereto, the values of the phase amount Φ is a value close to an integral multiple of 2π.

Comparison of FIGS. 11 and 12 clearly shows that the intensity I214 of the returning light 214 reduces as the phase amount Φ approaches the integral multiple of 2π. In other words, satisfying the condition of the expression 4 (or the expression 2) reduces the intensity I214 of the returning light 214. Thus, changing the length L22 of the waveguide 201 between the reflective portion 203 and the connection portion 213 to control the phase amount Φ enables reduction of the intensity I214 of the returning light 214.

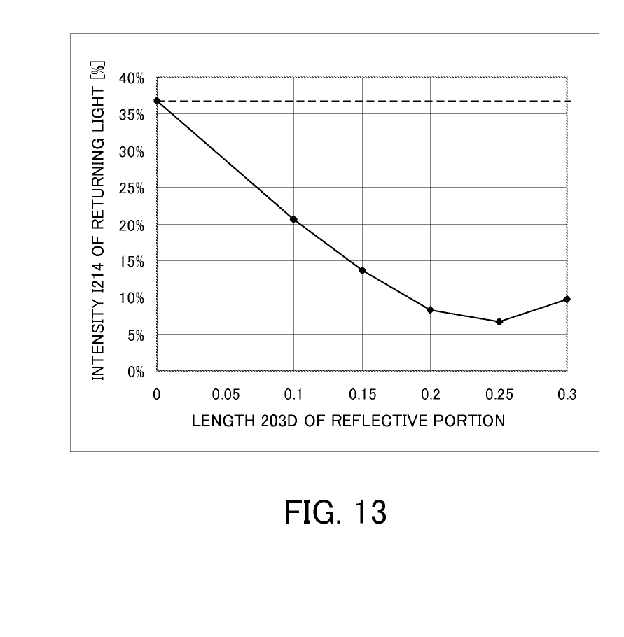

FIG. 13 is a graph showing calculation results of the intensity I214 of the returning light 214 in the three-dimensional structure C when the length L22 of the waveguide 201 between the reflective portion 203 and the connection portion 213 is set to 11.0P and a length 203D of the reflective portion 203 is changed, the calculation being performed by using the TMM.

In the graph of FIG. 13, a horizontal axis indicates the length 203D of the reflective portion 203 normalized by the lattice period P, and a vertical axis indicates the intensity I214 of the returning light 214 when the intensity of the input light is 1. In FIG. 13, a broken line indicates the intensity of the returning light 214 when no reflective portion 203 is provided.

As shown in FIG. 13, providing the reflective portion 203 suppresses the intensity of the returning light 214 to a lower level than the intensity indicated by the broken line. Thus, changing the length 203D of the reflective portion 203 to control a reflectance of the reflective portion 203 enables suppression of the intensity of the returning light 214.

As described above, the structure included in the output region in the three-dimensional structure in this embodiment may be a structure other than a waveguide formed by providing a linear defect in the three-dimensional photonic crystal, or a structure in which a tapered defect is provided in the three-dimensional photonic crystal. Further, the structure included in the output region may be a waveguide formed by providing in the three-dimensional photonic crystal a line defect extending in a direction different from that of a waveguide extending from the input portion to the connection portion.

Moreover, the structure included in the output region may be a structure having no photonic crystal structure, or may be a region formed by spatially homogeneously providing a medium such as air. Furthermore, the output region may include a thin line waveguide or a planar waveguide.

In addition, appropriately designing the reflective portion provided in the waveguide in the three-dimensional photonic crystal depending on the structure of the output region enables suppression of the returning light. Suppressing the returning light to increase the intensity of the light output to the output region enables improvement of the coupling efficiency of the light propagating in the waveguide and the light propagating in the output region.

Embodiment 3 described the case where providing the reflective portion in the waveguide in the photonic crystal and satisfying the conditions of the expressions 4 and 5 (or the conditions of the expressions 2 and 3) suppress a reflected wave generated at the connection portion between the structures which cause the light to propagate therein in the mutually different guide modes, thereby improving the coupling efficiency. Further, changing the length of the waveguide between the reflective portion and the connection portion to control the phase amount Φ enables satisfaction of the condition of the expression 4 (or the expression 2). Moreover, changing the shape of the reflective portion to control the reflectance of the reflective portion enables satisfaction of the condition of the expression 5 (or the expression 3).

In the three-dimensional structure of the present invention, the structure of the waveguide provided in the photonic crystal is not limited to that of each embodiment. For example, one of the columnar structures forming the photonic crystal may be formed of a medium having a refractive index lower than that of a medium forming the other columnar structures, and thereby the one columnar structure may serve as a line defect forming a waveguide.

Moreover, in the present invention, the method for controlling the phase amount Φ is not limited to that of each embodiment. For example, the shape of the reflective portion may be changed to control the phase amount Φ. Further, the medium forming the reflective portion may be changed to control the phase amount Φ. Furthermore, the length L between the reflective portion and the connection portion and the shape or the medium of the reflective portion may be simultaneously changed to control the phase amount Φ.

In addition, in the present invention, the reflectance of the reflective portion may be controlled by changing not only the shape of the reflective portion but also the medium or the position of the reflective portion.

Moreover, the number of the reflective portion is not limited to one, and plural reflective portions may be provided. Providing the plural reflective portions can reduce a change in intensity of the returning light with respect to a change in shape of the reflective portion, the reflectance of the medium forming the reflective portion or the position of the reflective portion. In other words, when a three-dimensional structure including an anti-reflection structure is manufactured, providing plural reflective portions reduces an influence of manufacturing errors, thereby facilitating the manufacturing.

### Embodiment 4

A light-emitting device including an anti-reflection structure, which is Embodiment 4 of the present invention, will be described. The light-emitting device of Embodiment 4 includes, in a three-dimensional photonic crystal having a complete photonic band gap, a waveguide formed by a line defect, a resonator formed by a point defect, a mode conversion structure, and an anti-reflection structure.

A point defect whose shape and medium are appropriately selected functions as a resonator having a resonance mode at a specific frequency in the complete photonic band gap. In the resonator, a light-emitting medium (gain medium) whose emission spectrum contains a resonance wavelength is disposed.

Energy supplied to the light-emitting medium with an electromagnetic wave or an electric current from the outside excites the light-emitting medium to cause it to emit light, and the emitted light is amplified in the resonator. This realizes a light-emitting device with an extremely high efficiency such as a laser or a LED.

When, near a point defect resonator, a waveguide is disposed which causes light to propagate therein in a guide mode 1 (first guide mode) having a frequency of a resonance mode of that resonator, light generated in the resonator is coupled with the light propagating in the waveguide in the guide mode 1 to be extracted to the outside of the resonator. The extracted light propagates in the waveguide in the guide mode 1.

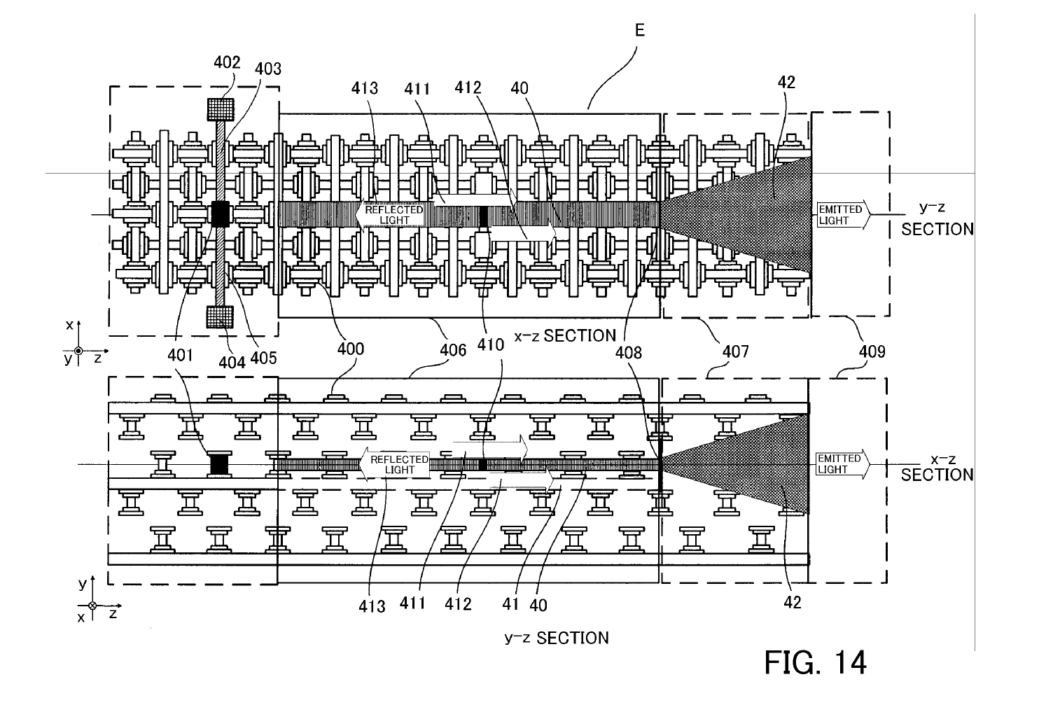

FIG. 14 shows a schematic configuration of a light-emitting device E including an anti-reflection structure, whish is Embodiment 4. Upper and lower sides of FIG. 14 respectively show x-z and y-z sections of the light-emitting device E.

The light-emitting device E includes a resonator (point defect resonator) 401 formed by providing a point defect 401 in a three-dimensional photonic crystal structure (hereinafter simply referred to as a photonic crystal) 400 having the same structure as that in Embodiment 2. The photonic crystal 400 includes a p-type electrode 402, a p-type carrier conducting pathway 403, an n-type electrode 404, and an n-type carrier conducting pathway 405.

In the point defect resonator 401, an active portion that receives carriers to emit light is formed. Holes are supplied to the resonator 401 through the p-type electrode 402 and the p-type carrier conducting pathway 403, and electrons are supplied to the resonator 401 through the n-type electrode 404 and the n-type carrier conducting pathway 405. The holes and the electrons are coupled together in the resonator 401 to emit light, thereby performing laser oscillation.

In order to extract the light to the outside of the resonator 401, the light-emitting device E includes a waveguide (first waveguide). The waveguide 406 has a columnar structure extending in a z-axis direction. More specifically, the waveguide 406 includes, in the photonic crystal 400, a first line defect 40 formed of a medium having a refractive index equal to that of a medium (first medium) forming the columnar structure, and a second line defect 41 formed in a layer different from a layer in which the first line defect 40 is formed. The waveguide 406 causes light to propagate in a guide mode 1 (first guide mode) having a frequency of the resonance mode of the resonator 401. Disposing the waveguide 406 at an appropriate position with respect to the resonator 401 enables efficient conversion of light present in the resonance mode into light propagating in the waveguide 406 in the guide mode 1.

At an end of the waveguide 406, the mode conversion structure (also referred to as an emission pattern control structure) is provided for emission of light with an arbitrary guide mode pattern to the outside of the photonic crystal 400. In Embodiment 4, as an example of the mode conversion structure, a waveguide (Third waveguide) 407 including a tapered line defect 42 in which a size of a section orthogonal to a direction in which the waveguide 406 extends (guide direction) gradually increases in the guide direction is provided. A region where the tapered waveguide 407 is disposed corresponds to a first region (output region).

The waveguide 406 and the tapered waveguide 407 are connected with each other via a connection portion 408. The tapered waveguide 407 is also connected with a free space (second region) which is formed outside the photonic crystal. The tapered waveguide 407 is capable of converting a guide mode pattern of light propagating in the waveguide 406 into a guide mode pattern having a monomodal intensity distribution in a section orthogonal to the guide direction and a size according to the tapered shape. Connecting such a tapered waveguide 407 with the end of the waveguide 406 enables extraction of light from the photonic crystal 400 to the outside of the photonic crystal, while controlling the guide mode pattern of the light propagating in the tapered waveguide 407.

Thus, providing the point defect resonator 401, the waveguide 406 and the mode conversion structure (tapered waveguide 407) in the photonic crystal having the complete photonic band gap enables acquisition of a light-emitting device.

In the light-emitting device, a reflected wave is generated at the connection portion 408 between the waveguide 406 and the mode conversion structure (tapered waveguide 407), and at a connection portion between the mode conversion structure and the free space outside the photonic crystal. The generated reflected wave is not emitted to the outside of the photonic crystal 400, but propagates in the waveguide 406 toward the point defect resonator 401 to become a loss.

In Embodiment 4, a reflective portion 410 is provided as an anti-reflection structure in such a light-emitting device. The reflective portion 401 is provided as a defect in the first line defect 40 forming the waveguide 406. The reflective portion 410 is formed of a medium having a refractive index different from that of a medium forming the first line defect 40. The reflective portion 410 has a homogeneous refractive index distribution in its entire section, which is orthogonal to the guide direction in which the first line defect 40 extends. A shape and a size (width and height) of the section, which is orthogonal to the guide direction, of the reflective portion 410 are equal to those of a section, which is orthogonal to the guide direction, of the first line defect 40 forming the waveguide 406.

When the light propagating in the waveguide 406 reaches the reflective portion 410, the reflective portion 410 disturbs a guide mode pattern of the light. The photonic crystal 400 present around the reflective portion 410 has the complete photonic band gap, and no radiation mode other than the guide mode is present. Thus, the light propagating in the waveguide 406 can be prevented from being coupled with light propagating in the radiation mode to become a loss.

Part of the light whose guide mode pattern has been disturbed by the reflective portion 410 is coupled with the light propagating in the waveguide 406 toward the connection portion 408. In other words, part of the light propagating in the waveguide 406 toward the reflective portion 410 is transmitted by the reflective portion 410 to become a transmitted wave. This transmitted wave is referred to as a transmitted wave 411.

Further, part of the light propagating in the waveguide 406 is transmitted through the reflective portion 410. The light transmitted through the reflective portion 410 is reflected by the connection portion 408 or the connection portion between the tapered waveguide 407 and the free space, is multiply-reflected between the reflective portion 410 and the connection portion 408. Of such a reflected wave, light propagating in the waveguide 406 toward the connection portion 408 is referred to as a reflected wave 412.

The transmitted wave 411 and the reflected wave 412 mutually interfere to become light propagating in the waveguide 406 toward the connection portion 408. In the light entering from the point defect resonator 401 and propagating in the waveguide 406, light which is not coupled with an interfered wave of the transmitted wave 411 and the reflected wave 412 is reflected to return to the point defect resonator 401. The returning light 413 is not extracted to the outside of the photonic crystal 400, but becomes a loss.

As in Embodiments 1 to 3, appropriately selecting a shape and a medium of the reflective portion 410 and a position of the reflective portion 410 and providing the reflective portion 410 so as to satisfy the conditions of the expressions 4 and 5 (ideally, so as to satisfy the conditions of the expressions 2 and 3) enables suppression of intensity of the returning light 413. The Suppression of the intensity of the returning light 413 increases intensity of the light propagating in the waveguide 406 toward the connection portion 408, thereby increasing intensity of light output (emitted) to the free space. In other words, the coupling efficiency of the light propagating in the waveguide 406 and the light propagating in the free space can be improved.

As described above, providing the reflective portion 410 in the line defect forming the waveguide 406 enables significant disturbance of the guide mode pattern of the light propagating in the waveguide 406. As a result, according to the shape, the medium and the position of the reflective portion 410, a reflectance of the reflective portion 410 can be greatly changed, which makes it possible to control the reflectance to an arbitrary value.

Further, since providing the line defect in the reflective portion 410 does not disturb the structure of the photonic crystal 400, an optical confinement effect obtained by the complete photonic band gap is prevented from being changed due to the provision of the reflective portion 410. Moreover, the reflective portion 410 has a homogeneous refractive index distribution in the section orthogonal to the guide direction in which the first line defect 40 extends. Thus, the reflective portion 410 can be easily manufactured without any need to adjust the shape of the reflective portion 410 in the section orthogonal to the guide direction.

Moreover, the reflectance of the reflective potion 410 can be easily controlled by adjusting a length of the reflective potion 410 in a direction parallel to the guide direction.

In Embodiment 4, the point defect resonator 401 and the waveguide 406 are provided in the photonic crystal 400 having the complete photonic band gap, and the tapered waveguide 407 is disposed at the end of the waveguide 406. Thus, a light-emitting device that emits light to the outside of the photonic crystal 400 while converting the guide mode pattern can be obtained.

In such a light-emitting device, providing the anti-reflection structure in the waveguide 406 enables suppression of generation of the reflected waves at the connection portion 408 between the waveguide 406 and the tapered waveguide 407 and at the end of the tapered waveguide 407. The use of the anti-reflection structure in this embodiment for the light-emitting device including the point defect resonator 401, the waveguide (line defect) 406 and the mode conversion structure (tapered waveguide) 407 enables realization of a high-performance laser device with a reduced loss and a controlled guide mode pattern of emitted light.

### Embodiment 5

In the case of the three-dimensional structure of Embodiment 1 including the anti-reflection structure, an anti-reflection effect may be small at a certain frequency. Embodiment 5 describes a structure capable of further improving the anti-reflection effect. Specifically, Embodiment 5 describes a three-dimensional structure characterized in that waveguides optically coupled with a reflective portion are different from each other.

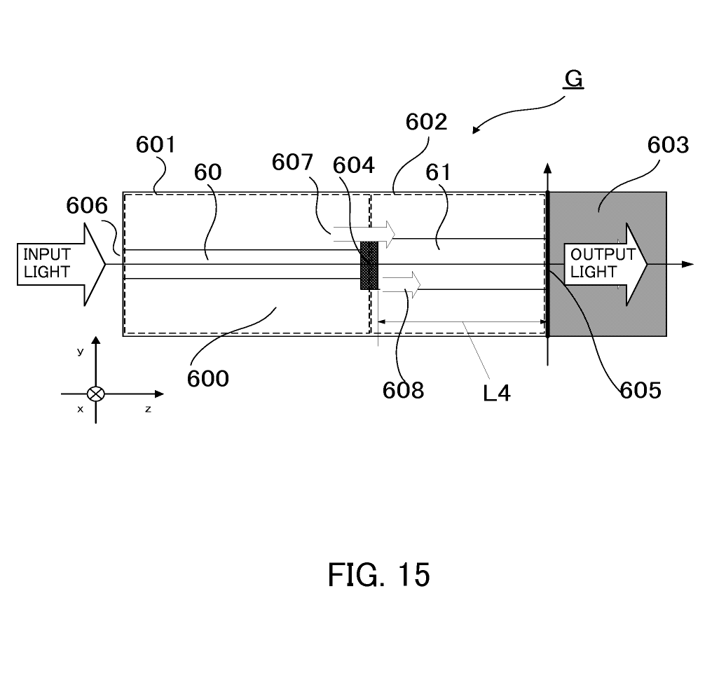

FIG. 15 shows a schematic configuration of a three-dimensional structure D including an anti-reflection structure.

The three-dimensional structure D includes a waveguide (first waveguide) 601 and a waveguide (second waveguide) 602 in a photonic crystal 600. Reflective portions 604 are provided in the first waveguide 601 and the second waveguide 602. The three-dimensional structure D further includes an output region (first region) 603.

The photonic crystal 600 has a structure with a three-dimensionally periodic refractive index distribution, in other words, a structure in which a first medium and a second medium having a smaller refractive index than that of the first medium are periodically arranged. The photonic crystal 600 has a complete photonic band gap.

The waveguide 601 has a structure obtained by providing a line defect 60 in the photonic crystal 600. A guide mode of light propagating in the waveguide 601 is referred to as a guide mode 1 (first guide mode).

The waveguide 602 has a structure obtained by providing a line defect 61 in the photonic crystal 600. The line defect 61 of the waveguide 602 extends in a same direction as that of the line defect 60 of the waveguide 601. The line defect 61 of the waveguide 602 is formed into a shape or of a medium different from that of the line defect 60 of the waveguide 601. A guide mode of light propagating in the waveguide 602 is referred to as a guide mode 2 (second guide mode). The guide mode 2 is a different mode from the guide mode 1.

The output region 603 has a structure different from those of the waveguides 601 and 602. In the output region 603, light propagates in a guide mode different from the guide modes 1 and 2. The guide mode of the light propagating in the output region 603 is referred to as a guide mode 3 (third guide mode).

A band of a guide mode frequency of the light propagating in the waveguide 601, a band of a guide mode frequency of the light propagating in the waveguide 602, and a band of a guide mode frequency of the light propagating in the output region 603 include a same frequency at least in parts thereof.

The waveguide 602 and the output region 603 are connected with each other via a connection portion 605.

The three-dimensional structure D further includes a reflective portion 604. The reflective portion 604 is disposed at a position in contact with the line defect 60 of the waveguide 601 and the line defect 61 of the waveguide 602, and is formed by providing a defect in part of the line defect 60, or in part of the line defect 61, or both.

The reflective portion 604 is provided as a defect formed of a medium having a refractive index different from those of media forming the line defects 60 and 61. The reflective portion 604 has a homogeneous refractive index distribution (same refractive index) over the entire section orthogonal to the direction (guide direction) in which the line defects 60 and 61 extend.

A shape and a size of the section, which is orthogonal to the guide direction, of the reflective portion 604 are equal to those of the section, which is orthogonal to the guide direction, of the waveguide 601 or 602 that is in contact with the section of the reflective portion 604.

When the reflective portion 604 disturbs the guide mode pattern of the light propagating in the waveguide 601, part of the light is coupled with light propagating in the waveguide 601 in the guide mode 1 toward an input portion 606. The other part of the light is coupled with light propagating in the waveguide 602 in the guide mode 2 toward the connection portion 605. In other words, part of the light propagating in the waveguide 601 is reflected by the reflective portion 604, while the other part of the light is transmitted therethrough. The light transmitted through the reflective portion 604 is referred to as a transmitted wave 607.

Part of input light entering from the input portion 606 to propagate in the waveguide 601 is transmitted through the reflective portion 604 to propagate in the waveguide 602 toward the connection portion 605. The light propagating in the waveguide 601 toward the connection portion 605 is coupled with light propagating in the output region 603 in the guide mode 3 via the connection portion 605.

The guide mode 2 of the light propagating in the waveguide 602 and the guide mode 3 of the light propagating in the output region 603 are different guide mode from each other. Thus, part of the light that has reached the connection portion 605 is coupled with the light propagating in the waveguide 602 toward the reflective portion 604. In other words, part of the light that has reached the connection portion 605 is reflected by the connection portion 605 to become a reflected wave. The reflected wave propagates in the waveguide 602 and repeats reflection at the reflective portion 604, propagation in the waveguide 602 and reflection at the connection portion 605. Of such a reflected wave, light propagating in the waveguide 602 toward the connection portion 605 is referred to as a reflected wave 608.

The transmitted wave 607 and the reflected wave 608 mutually interfere to become light propagating in the waveguide 602 toward the connection portion 605. In the input light entering from the input portion 606 and propagating in the waveguide 601, light which is not coupled with an interfered wave of the transmitted wave 607 and the reflected wave 608 is reflected to return to the input portion 606. This light is not output to the output region 603 but becomes a loss. In description below, in the input light entering from the input portion 606, light which is not output to the output region 603 but returns to the input portion 606 to become a loss is referred to as returning light 609.

In this case, if the transmitted and reflected waves 607 and 608 mutually interfere in a state where their phases are different from each other by an integral multiple of 2π, the transmitted and reflected waves 607 and 608 reinforce each other. As a result, the input light is strongly coupled with the interfered wave, and thereby intensity I609 of the returning light 609 is reduced. An influence of the interference increases as amplitudes of the transmitted and reflected waves 607 and 608 are more equal to each other, reducing the intensity of the returning light 609. The reduced intensity of the returning light 609 increases intensity of the light propagating in the waveguide 601 toward the connection portion 605, resulting in increase of intensity of the light output to the output region 603. In other words, the coupling efficiency of the light propagating in the waveguide 601 in the guide mode 1 and the light propagating in the output region 603 in the guide mode 3 can be improved.

The intensity I609 of the returning light 609 can be represented by the following expression 12:

$$I 609 = 1 - [ \frac{( 1 - R 604 ) \cdot ( 1 - R 605 )}{\begin{matrix}1 + R 604 \cdot R 605 - \\ 2 \cdot \sqrt{R 604 \cdot R 605} cos ( Φ )\end{matrix}} ] \\ Φ = φ 604 + φ 605 + 2 {k}_{z} L 1 \qquad [ Expression 12 ]$$

In the expression 12, R604 denotes a power reflectance when the light propagating in the waveguide 602 in the guide mode 2 is reflected by the reflective portion 604. φ604 denotes a phase amount changed by the reflection of the light propagating in the waveguide 602 in the guide mode 2 at the reflective portion 604. R605 denotes a power reflectance when the light propagating in the waveguide 602 in the guide mode 2 is reflected by the connection portion 605. φ605 denotes a phase amount changed by the reflection of the light propagating in the waveguide 602 in the guide mode 2 at the connection potion 605. Kz denotes a size of a wave vector, in a direction parallel to the guide direction, of the light propagating in the waveguide 602 in the guide mode 2. L1 denotes a length of the waveguide 602 from the reflective portion 604 to the connection portion 605.

Conditions where the intensity I609 of the returning light 609 is minimum, that is, conditions to be satisfied to reduce the returning light 609 can be derived from the expression 12, which are represented by the following expressions 13 and 14:

Φ=φ604+φ605+2kzL1=2nπ (n is an arbitrary integer) [Expression 13]

R604=R605 [Expression 14]

The expression 13 is a conditional expression relating to a phase of the light propagating in the waveguide 602. A sum of a phase amount 2·Kz·L1 provided by propagation of the light in the waveguide 602 between the reflective portion 604 and the connection portion 605 and phase amounts φ604 and φ605 changed by reflections at the reflective portion 604 and the connection portion 605 is defined as a phase amount Φ. Symbol n denotes an arbitrary integer.

The expression 14 is a conditional expression relating to an amplitude of the light propagating in the waveguide 601. Designing a structure of the reflective portion 604 so as to satisfy the expressions 13 and 14 enables reduction of the returning light 609.

In the expression 13, the phase amount φ605 is determined depending on a structure of the waveguide 602 or the output region 603, a positional relationship thereof, and a distance therebetween. The phase amount φ604 is determined depending on a shape of the reflective portion 604, a position of the reflective portion 604, a medium forming the reflective portion 604, and the structure of the waveguide 602. Changing the position of the reflective portion 604 along the guide direction in which the waveguide 602 (or the waveguide 601) extends causes the phase amount φ604 to periodically fluctuate at a periodic interval of the photonic crystal 600 in a same direction as the guide direction in which the waveguide 602 extends. Kz which is a size of a wave vector, in a direction parallel to the guide direction, of the light propagating in the waveguide 602 is determined based on the structure of the waveguide 602. L1 which is a length of the waveguide 602 is determined based on the position of the reflective portion 604.

Further, the condition of the expression 13 shows that the intensity of the returning light 609 can be reduced as the value of the phase amount Φ approaches an integral multiple of 2π. In other words, changing the position of the reflective portion 604 to set the length L1 of the waveguide 602 and the phase amount φ604 to appropriate values enables control of the value of the phase amount Φ for satisfying the condition of the expression 13. Moreover, changing the shape of the reflective portion 604 and the medium forming the reflective portion 604 enables appropriate setting of the value of the phase amount φ604, which makes it possible to control the value of the phase amount Φ so as to satisfy the condition of the expression 13. Furthermore, changing the structure of the waveguide 602 so as to set the size Kz of the wave vector, in the direction parallel to the guide direction, of the light propagating in the waveguide 602 and the phase amounts φ604 and φ605 to appropriate values enables control of the value of the phase amount Φ for satisfying the condition of the expression 13.

In the expression 14, the reflectance R605 of the connection portion 605 is determined depending on the structures of the waveguide 602 and the output region 603, a positional relationship thereof, and a distance therebetween. The reflectance R604 of the reflective portion 604 is determined depending on the shape and the position of the reflective portion 604, the medium forming the reflective portion 604, and the structure of the waveguide 602. Changing the position of the reflective portion 604 along the guide direction in which the waveguide 602 extends causes the reflectance R604 to periodically fluctuate at a periodic interval of the photonic crystal 600 in a same direction as the guide direction in which the waveguide 602 extends.

The condition of the expression 14 shows that the returning light 609 can be reduced as the reflectances of the reflective portion 604 and the connection portion 605 are more similar to each other (preferably, matched). Changing the shape and the position of the reflective portion 604 and the medium forming the reflective portion 604 enables control of the reflectance R604 of the reflective portion 604 for satisfying the condition of the expression 14. Changing the structure of the waveguide 602 enables control of the reflectances R604 and R605 for satisfying the condition of the expression 14.

Satisfying the conditions of the expressions 13 and 14 in these manners enables suppression of the returning light 609, thereby reducing a loss. Further, suppressing the returning light 609 to increase the intensity of the light output to the output region 603 enables improvement of the coupling efficiency of the light propagating in the waveguide 601 in the guide mode 1 and the light propagating in the output region 603 in the guide mode 3.

In the case of the three-dimensional structure of Embodiment 1 including the anti-reflection structure, an anti-reflection effect may be small at a certain frequency. Hereinafter, description will be made of the reasons that the structure of Embodiment 5 can improve the anti-reflection effect.

The three-dimensional structure of Embodiment 1 shown in FIG. 1 includes the waveguides having same structures as those of the waveguides 601 and 602 shown in FIG. 15.

In order to satisfy the condition of the expression 14, the shape, the position and the medium of the reflective portion 604 are appropriately set.

Then, in order to satisfy the condition of the expression 13, the structure of the reflective portion 604 and the length L1 of the waveguide 602 are appropriately set. The shape, the position and the medium of the reflective portion 604 are fixed at predetermined shape, position and medium to satisfy the condition of the expression 14, and thereby the phase amount φ604 of the reflective portion 604 is fixed. Further, the reflectance R604 and the phase amount φ604 of the reflective portion 604 periodically fluctuate depending on the position of the reflective portion 604 (that is, the length L1 of the waveguide 602) in the direction in which the waveguide 602 extends. Therefore, the length L1 of the waveguide 602 is limited to discrete values which satisfy the condition of the expression 14 (that is, values which makes the reflectance R604 of the reflective portion 604 equal to the reflectance R605 of the connection portion 605). Thus, at the certain frequency, even though the length L1 of the waveguide 602 is changed, the condition of the expression 13 may not be sufficiently satisfied, which results in a small anti-reflection effect.

On the other hand, in the three-dimensional structure of Embodiment 5, the waveguides 601 and 602 have mutually different structures, and therefore, at the certain frequency, the conditions of the expressions 13 and 14 are satisfied to suppress the returning light 609. The condition of the expression 14 can be satisfied by changing the structure of the waveguide 602, in addition to the shape, the position and the medium of the reflective portion 604, to control the reflectances R604 and R605 of the reflective portion 604 and the connection portion 605. Changing both of the structures of the waveguide 602 and the reflective portion 604 can more freely control each value to set it to an appropriate value, as compared with Embodiment 1. The condition of the expression 13 can be satisfied by appropriately setting the structure of the waveguide 602, in addition to the structure of the reflective portion 604 and the length L1 of the waveguide 602. Changing the structure of the waveguide 602 enables control of the size Kz of the wave vector in the guide direction, the phase amount φ604 of the reflective portion 604, and the phase amount φ605 of the connection portion 605. Changing the structures of the reflective portion 604 and the waveguide 602 and the length L1 can more freely control each value to set it to an appropriate value, thereby satisfying the conditions of the expressions 13 and 14. Thus, at the certain frequency, the conditions of the expressions 13 and 14 can be satisfied to obtain a higher anti-reflection effect.

Particularly, changing the structure of the waveguide 602 and the size Kz of the wave vector, in the guide direction, of the light propagating in the waveguide 602 significantly changes the phase amount due to multiplication of the length L1 of the waveguide 602 by the coefficient “2”, which is effective for satisfying the condition of the expression 13.

In the condition of the expression 13, each of the reflectances R604 and R605 of the reflective portion 604 and the connection portion 605 varies depending on a frequency of the light propagating in the waveguide 602. Further, in the condition of the expression 14, the phase amounts φ604 and φ605, and the size Kz of the wave vector, in the guide direction, of the light propagating in the waveguide 602 vary depending on that frequency.

In order to obtain an anti-reflection effect in a wide frequency band, it is necessary that the above values be set as close as possible to values satisfying the conditions of the expressions 13 and 14 in a wavelength range as wide as possible.

As described in this embodiment, providing a different structure to the waveguide 602 from that of the waveguide 601 to control the structure of the waveguide 602 can more freely control the structure of the reflective portion 604 and the length L1 of the waveguide 602, which makes it possible to appropriately set the values in the expressions 13 and 14. As a result, the conditions of the expressions 13 and 14 are satisfied, thereby making it possible to obtain an anti-reflection effect in a wider frequency band.

When the size Kz of the wave vector of the waveguide 602 fluctuates according to the frequency, the value of the phase amount φ is significantly changed due to multiplication of the length L1 of the waveguide 602 by the coefficient “2”, which makes it easy to fail to satisfy the condition of the expression 13. In order to obtain the anti-reflection effect in a wide frequency band, satisfying the conditions of the expressions 13 and 14 and controlling each value so as to make the length L1 of the waveguide 602 small are effective.

Satisfying the conditions of the expressions 13 and 14 is ideal.

However, the reflectance R604 of the reflective portion 604 and the phase amount Φ which satisfy conditions of the following expressions 15 and 16 provides a sufficient effect for suppressing the returning light and a sufficient effect for improving the coupling efficiency.

cos(Φ)≧cos(25°) [Expression 15]

R605−0.30≦R604≦R605+0.20 [Expression 16]

The expressions 15 and 16 can be rewritten in the following general forms:

Φ=φ1+φ2+2KzL

cos(Φ)≧cos 25°

R2−0.30≦R1≦R2+0.20.

R1 and φ1 respectively correspond to the reflectance R604 and the phase amount φ604 of the reflective portion 604. R2 and φ2 respectively correspond to the reflectance R605 and the phase amount φ605 of the connection portion 605. L corresponds to the length L1 of the waveguide 602 between the reflective portion 604 and the connection portion 605.

It is more preferable to provide the reflective portion 604 so as to satisfy conditions of the following expressions 17 and 18. The reflectance R604 of the reflective portion 604 has a value from 0.0 to 60, irrespective of the reflectance R605 of the connection portion 605. Further, it is desirable to set the reflectance R604 of the reflective portion to a value equal to or less than that of the reflectance R605 of the connection portion 605. These can reduce a change in intensity of the returning light with respect to a change of the phase amount Φ.

cos(Φ)≧cos(15°) [Expression 17]

R605−0.20≦R604≦R605+0.10 [Expression 18]

A reduction amount of the intensity of the returning light can be arbitrarily set, and a conditional expression for the reflective portion 604 in this case can be derived from the expression 12. The reflectance R604 and the phase amount Φ of the reflective portion 604 preferably satisfy conditions of expressions 19 and 20 to reduce the intensity of the returning light to a level less than a half of that when no reflective portion 604 is provided.

cos(Φ)>cos [43°×(1−R605)] [Expression 19]

0.5×R6052≦R604≦R605+0.15 [Expression 20]

It is more preferable that the reflectance R604 and the phase amount Φ of the reflective portion 604 be set such that the intensity of the returning light is reduced less than ⅓ when no reflective portion is provided. Thus, it is preferable to provide the reflective portion 604 so as to satisfy conditions of expressions 21 and 22.

cos(Φ)>cos [35°×(1−R5605)] [Expression 21]

0.8×R6052≦R604≦R605+0.12 [Expression 22]

In Embodiment 5, the three-dimensional photonic crystal may employ any type of a photonic crystal.

Further, a light-emitting device can be realized by using a gain medium disposed in the defect and an energy supplying means.

Moreover, it is preferable in applications of the three-dimensional structure to devices that the first waveguide and the second waveguide be formed so as to cause light to propagate therein in a single guide mode.

As described above, each of Embodiments 1 to 5 suppresses the reflected wave generated at the connection portion connecting the waveguide in the three-dimensional photonic crystal with the region in which the light propagates in a guide mode different from the guide mode in the waveguide, and improves the coupling efficiency of the lights of both guide modes, by using an easily manufactured structure. Thus, each of Embodiments 1 to 5 can realize an optical element having good characteristics as a resonator or a waveguide.

Furthermore, the present invention is not limited to these embodiments and various variations and modifications may be made without departing from the scope of the present invention.

This application claims the benefit of Japanese Patent Application Nos. 2008-032734, filed on Feb. 14, 2008, and 2009-26619, filed on Feb. 6, 2009, which are hereby incorporated by reference herein in their entirety.

What is claimed is:

1. A three-dimensional structure comprising:
a first waveguide which is formed as a line defect in a three-dimensional photonic crystal constituted by periodically arranging a first medium and a second medium having a refractive index smaller than that of the first medium, and which causes light to propagate therein in a first guide mode;
a second waveguide which is formed as a line defect in the three-dimensional photonic crystal, and which causes light to propagate therein in a second guide mode;
reflective portions provided in the first and second waveguides to respectively reflect parts of the lights propagating in the first and second waveguides; and
a first region connected to the second waveguide so as to cause at least part of the light that has propagated in the second waveguide via the reflective portion to propagate therein in a third guide mode different from the second guide mode,
wherein the reflective portions are formed of media having refractive indexes different from those of media forming the first and second waveguides, and
wherein each of the reflective portions has a homogeneous refractive index distribution in an entire section orthogonal to a direction in which each of the first and second waveguides extends.

2. A three-dimensional structure according to claim 1,
wherein the reflective portion satisfies the following conditions:
Φ=φ1+φ2+2K_{z}L
cos(Φ)≧cos 25°
R2−0.30≦R1≦R2+0.20.
where:
R1 and φ1 respectively represent a reflectance when the light propagating in the second waveguide is reflected by the reflective portion and a phase amount of the reflected light, the phase amount being changed by reflection at the reflective portion;
R2 and φ2 respectively represent a reflectance when the light propagating in the second waveguide is reflected at a connection portion where the second waveguide is connected with the first region and a phase amount of the reflected light, the phase amount being changed by reflection at the connection portion;
Kz represents a size of a wave vector, in a direction parallel to the direction in which the second waveguide extends, of the light propagating in the second waveguide; and
L represents a length from the reflective portion in the second waveguide to the first region.

3. A three-dimensional structure according to claim 1,
wherein the first and second waveguide are a same waveguide.

4. A three-dimensional structure according to claim 1,
wherein the first and second waveguide are separate waveguides.

5. A three-dimensional structure according to claim 1,
wherein a shape and a size of a section of the reflective portion are equal to those of the section of one of the first and second waveguides, the section being orthogonal to the direction in which the first waveguide extends.

6. A three-dimensional structure according to claim 6,
wherein the reflective portion is formed of a medium having a refractive index equal to that of the second medium.

7. A three-dimensional structure according to claim 1,
wherein each of the first and second waveguides causes the light to propagate therein in a single guide mode.

8. A light-emitting device comprising:
a three-dimensional structure according to claim 1;
a resonator formed by providing a point defect in a three-dimensional photonic crystal; and
a second region which is disposed outside the three-dimensional photonic crystal and has a homogeneous refractive index distribution,
wherein a gain medium is disposed in the resonator, and
wherein light generated in the resonator by exciting the gain medium is amplified by the resonator, and the amplified light propagates in the first waveguide and the first region to be output to the second region.
